(19) United States
(12) Patent Application Publication
(10) Pub. No.: US 2008/0033757 A1
(43) Pub. Date: Feb. 7, 2008

(54) Conversation data capture and processing platform

(76) Inventors: Jeffrey A. Kozloff, North Wales, PA (US); Jamison S. Barnett, Pottstown, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/888,399

(22) Filed: Jul. 31, 2007

Related U.S. Application Data
(60) Provisional application No. 60/834,711, filed on Aug. 1, 2006.

(51) Int. Cl. G06Q 10/00; G06F 17/30; G06F 3/00; G06F 7/00

(52) U.S. Cl. 705/2; 707/10; 707/3; 715/716

(57) ABSTRACT

Computer-implemented interactive system and methods allowing for the capture and processing of conversation data. In an illustrative implementation, a computing environment comprises a conversation data processing engine, a plurality of data stores allowing for the storage and retrieval of raw and/or formatted conversation and conversation session data, and a recording means allowing for the recording of conversations. In an illustrative implementation, the participating users can employ one or more recording means to electronically capture a conversation. The recorded interactions along with other selected user data can be electronically communicated to the conversation processing engine for processing and storage. In an illustrative implementation, point-of-practice patient/doctor interaction data is electronically captured and processed to generate patient-agnostic formatted data for use in various applications.

### CLAIM OR PRIORITY AND CROSS-REFERENCE

This non-provisional patent application claims priority to and the benefit of U.S. provisional patent application, 60/834,711, filed on Aug. 1, 2006, entitled, “SYSTEM AND METHODS FOR CAPTURING AND PROCESSING PATIENT INTERVIEWS” which is herein incorporated by reference in its entirety.

### BACKGROUND

There is a significant shift in decision-making and selection of services in the healthcare industry. The industry continues to evolve away from a physician-centric environment, in which the physician is the decision-maker and the patient is passive, towards a patient-centric market, whereby the physician and patient mutually identify a level of communication and decision-making that meets each patient's needs. As employers, insurers and the government all continue to assert more pressure on patients to manage their own care, patients are forced to better educate themselves and make tradeoffs, similar to other purchasing decisions, regarding their healthcare.

Thus, as in other industries, the point-of-purchase is one of the most important leverage points to capture and analyze customer behavior. In the healthcare industry, this means capturing data at the point-of-practice, where physicians and patients meet to discuss a patient-specific healthcare issue.

However, as the market continues to shift towards a more patient-centric environment, the research tools marketers use to capture customer data have not evolved accordingly. Currently, healthcare marketers are not privy to the information that is most important to their business: the dialogue that occurs between physicians and patients during office interactions. Without being able to hear the actual physician-patient interaction, marketers are left with numerous unanswered questions and forced to make assumptions about physician and patient attitudes and behaviors.

Current practices rely on post interview surveys of patients and doctors (usually independently) to capture data regarding a past doctor visit by a patient. Such practice is fraught with various problems including: the inability of the patient to accurately remember the content of their conversation with their doctor and/or vice versa, the inaccuracy of the information that the patient remembers was conveyed by/to the doctor, the inability of doctors to discuss patient information as governed by various rules and regulations on patient information privacy, and the inaccuracy of data arising from the effort of trying to reconstruct a patient/doctor interaction session after the fact.

Other industries also rely on information passed between a service provider and a customer/client. Such industries include but are not limited to the insurance, financial service, auto sales/service, banking, and accounting/audit industries. These industries, however, akin to the healthcare industry do not, with current practices, provide a facility to allow service providers and/or clients to record, track, store, manage, and/or process verbally communicated data. This lacking can lead to inaccurate and unreliable record keeping. Further, managers of service providers are not afforded a valuable data resource to assist them in evaluating the effectiveness of the service providers they are charged with monitoring and managing. Additionally, with conventional practices, clients/customers are not provided with an electronic record of verbal conversations occurring with service providers that can be used among other things to resolve disputes, chronicle service choices, confirm service requests and service fulfillments.

From the foregoing, it is appreciated that there exists a need for systems and methods that facilitate the capture, analysis, and reporting of interview/conversation data aimed to ameliorate the shortcomings of existing practices.

### SUMMARY

The herein described systems and methods provide a computer-implemented interactive system and methods allowing for the capture and processing of point-of-practice patient/doctor interaction data. In an illustrative implementation, a computing environment comprises a patient interview data processing engine, a plurality of data stores allowing for the storage and retrieval of raw and/or formatted point-of-practice interaction data, and a recording means allowing for the recording of patient/doctor interactions.

In an illustrative operation, participating users (e.g., doctors) are provided access to the exemplary computing environment as part of a patient data capture application. In the illustrative implementation, the participating users can employ one or more recording means to capture the interaction between a doctor and patient during a selected doctor/patient visit. In the illustrative implementation, such interaction can be captured using audio-visual recording means to allow for the audio/video recording of interactions. In the illustrative operation, the recorded interactions along with other selected patient data (e.g., patient chart) can be electronically communicated to the patient interview processing engine for processing. The processing can include but is not limited to removing indicators of the identity of cooperating parties of an interaction (e.g., patient, physician, nurse, caregiver, etc.—i.e., anyone being recorded in the interaction) to generate party-agnostic (e.g., “scrubbed”) data that complies with a selected patient data privacy policy.

Additionally, in the illustrative operation, the exemplary processing can include but is not limited to formatting the “scrubbed” data according to one or more selected format templates for subsequent communication to one or more cooperating parties.

In an illustrative implementation, the computing platform can comprise a computing application having one or more instructions to guide a healthcare interaction session capture process which allows data aggregators (operators) the ability to capture various healthcare interaction session data through the use of one or more selected electronic recording means (e.g., audio/visual recording means) operable to interface with the computing application for storage of captured healthcare interaction session data (e.g., interaction data between one or more of a patient, physician, nurse, caregiver, administrator, or other cooperating party). The application can comprise various features: a user interface for healthcare data aggregators to administer the collection and processing of healthcare interaction session data, a user interface for participating users (e.g., doctors and/or patients) to electronically communicate and interact with captured healthcare interaction session data (and other associated patient and/or doctor data), a user interface for cooperating parties (e.g., healthcare data consumers) to access and navigate through captured and processed healthcare data.

In an illustrative operation, the computing platform can allow participating patients the ability to retrieve and navigate through recorded interview data. In the illustrative operation, participating patients can employ such retrieved data to monitor healthcare attention and planning. Additionally, illustratively, the exemplary retrieved interview data can be shared by the participating patients with family, loved ones, other patients employing the computing platform, and/or other care givers to apprise such parties of the healthcare planning and attention that is being provided by one or more healthcare service providers with a given participating patient. In the illustrative operation, the ability to share the captured conversation data can depend on authorization to share the data as exemplarily provided by the owner (or generally, the source) of the conversation data (e.g., the patient, customer, client, vendor, supplier, or other party).

In an illustrative implementation, the herein described systems and methods can be deployed to capture and/or process conversation data occurring between various service providers/vendors and customers/clients. In the illustrative implementation, exemplary service providers/vendors can participate in various exemplary industries including but not limited to insurance, automobile/vehicle service/sales, banking, and financial services. In the illustrative implementation, the exemplary electronically captured data can be used to enhance the relationship between various service providers/vendors and customers/clients and customers/clients with one another.

In an illustrative implementation, the herein described systems and methods can be deployed as one or more portions of a social networking paradigm. In the illustrative implementation, participating users can electronically collaborate with a community of other participating users using the exemplary computing platform to share one or more portions of captured electronic conversation data (e.g., agnostic and/or non-agnostic redacted and/or un-redacted electronic captured conversation data) to obtain the community intelligence regarding a particular issue or subject (e.g., diabetes management, mortgage rates, etc.).

Other features of the herein described systems and methods are further described below.

### BRIEF DESCRIPTION OF THE DRAWINGS

The interactive systems and methods for the electronic capture and processing of conversation data are further described with reference to the accompanying drawings in which:

FIG. 1 is a block diagram of an exemplary computing environment in accordance with an illustrative implementation of the herein described systems and methods;

FIG. 2 is a block diagram of an exemplary networked computing environment in accordance with an illustrative implementation of the herein described systems and methods;

FIG. 3 is a block diagram showing the cooperation of exemplary components of an illustrative implementation in accordance with the herein described systems and methods;

FIG. 3A is a block diagram showing the cooperation of exemplary components of another illustrative implementation in accordance with the herein described systems and methods;

FIG. 4 is a block diagram showing an illustrative block representation of an illustrative implementation of an exemplary conversation data electronic capture and processing system in accordance with the herein described systems and methods;

FIG. 4A is a block diagram showing an illustrative block representation of another illustrative implementation of an exemplary conversation data electronic capture and processing system in accordance with the herein described systems and methods;

FIG. 5 is flow diagram showing illustrative processing performed to allow the capture and processing of conversation data in accordance with the herein described systems and methods;

FIG. 5A is flow diagram showing other illustrative processing performed to allow the capture and processing of exemplary conversation data in accordance with the herein described systems and methods;

FIG. 6 is flow diagram showing another illustrative processing performed to allow the electronic capture and processing of conversation data in accordance with the herein described systems and methods; and

FIG. 6A is flow diagram showing another illustrative processing performed to allow the electronic capture and processing of other exemplary conversation data in accordance with the herein described systems and methods.

### DETAILED DESCRIPTION

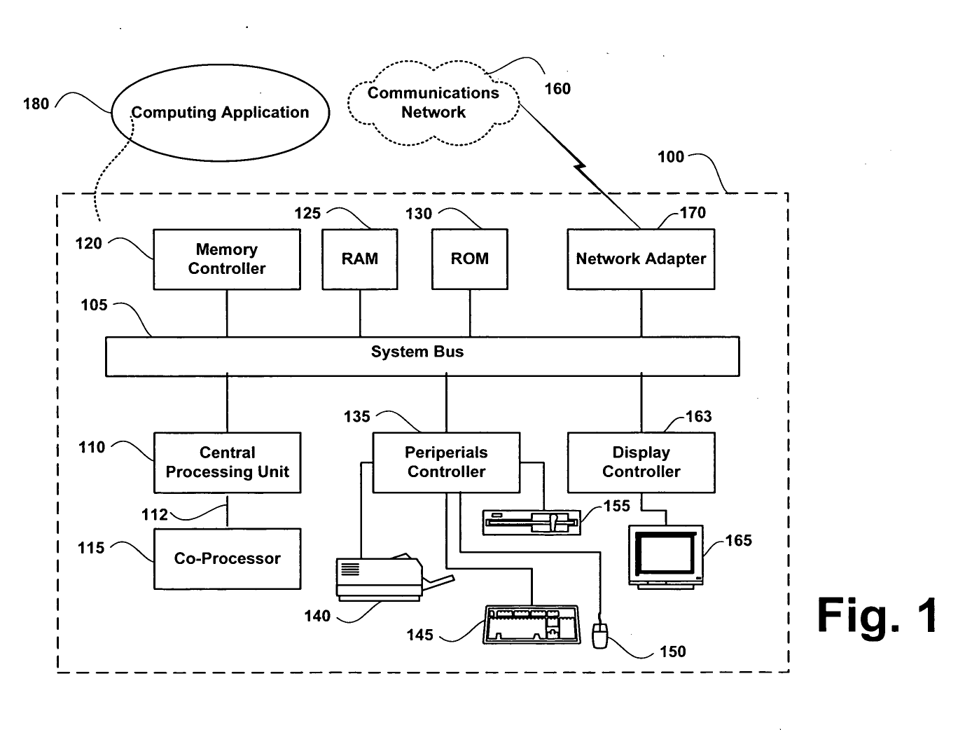

FIG. 1 depicts an exemplary computing system 100 in accordance with herein described system and methods. The computing system 100 is capable of executing a variety of computing applications 180. Computing application 180 can comprise a computing application, a computing applet, a computing program and other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to do work. In many known computer servers, workstations and personal computers CPU 110 is implemented by micro-electronic chips CPUs called microprocessors. A coprocessor 115 is an optional processor, distinct from the main CPU 110 that performs additional functions or assists the CPU 110. The CPU 110 may be connected to co-processor 115 through interconnect 112. coprocessor, which is designed to perform numeric calculations faster and better than the general-purpose CPU 110.

In operation, the CPU 110 fetches, decodes, and executes instructions, and transfers information to and from other resources via the computer's main data-transfer path, system bus 105. Such a system bus connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain peripherals controller 135 responsible for communicating instructions from the CPU 110 to peripherals,. such as, printer 140, keyboard 145, mouse 150, and data storage drive 155. Display 165, which is controlled by a display controller 163, is used to display visual output generated by the computing system 100. Such visual output may include text, graphics, animated graphics, audio, and video. The display controller 163 includes electronic components required to generate a video signal that is sent to display 165. Further, the computing system 100 can contain network adaptor 170 which may be used to connect the computing system 100 to an external communication network 160.

### Illustrative Computer Network Environment

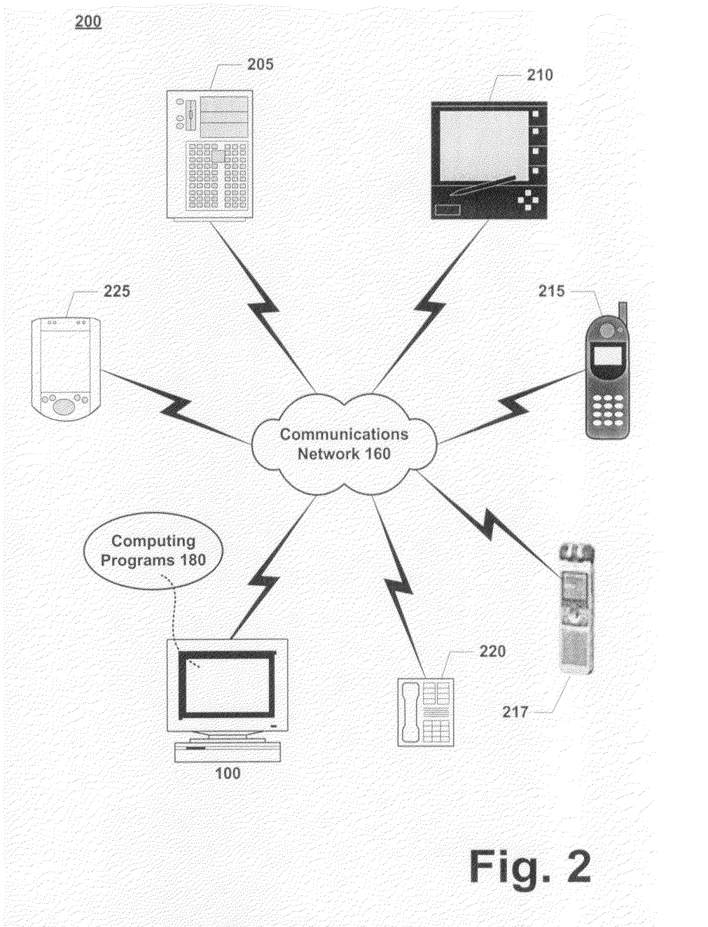

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server 205 may be interconnected via a communications network 160 (which may be either of, or a combination of a fixed-wire or wireless LAN, WAN, intranet, extranet, peer-to-peer network, virtual private network, the Internet, or other communications network) with a number of client computing environments such as tablet personal computer 210, mobile telephone 215, telephone 220, personal computer 100, digital voice recorder 217, personal digital assistant 225. In a network environment in which the communications network 160 is the Internet, for example, server 205 can be dedicated computing environment servers operable to process and communicate data to and from client computing environments 100, 210, 215, 217, 220, and 225 via any of a number of known protocols, such as, hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 100, 210, 215, 217, 220, and 225 can be equipped with operating system 180 operable to support one or more computing applications, such as a web browser (not shown), or other graphical user interface (not shown), or a mobile desktop environment (not shown) to gain access to server computing environment 205.

In operation, a user (not shown) may interact with a computing application running on a client computing environments to obtain desired data and/or computing applications. The data and/or computing applications may be stored on server computing environment 205 and communicated to cooperating users through client computing environments 100, 210, 215, 217, 220, and 225, over exemplary communications network 160. A participating user may request access to specific data and applications housed in whole or in part on server computing environment 205. These data may be communicated between client computing environments 100, 210, 215, 217, 220, and 220 and server computing environments for processing and storage. Server computing environment 205 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

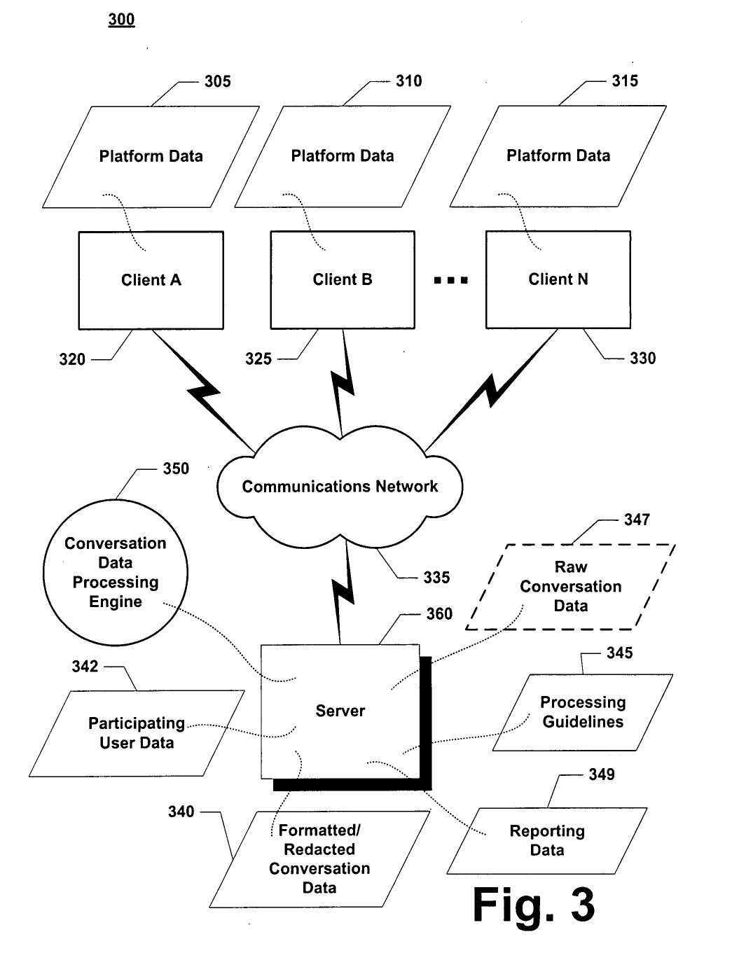

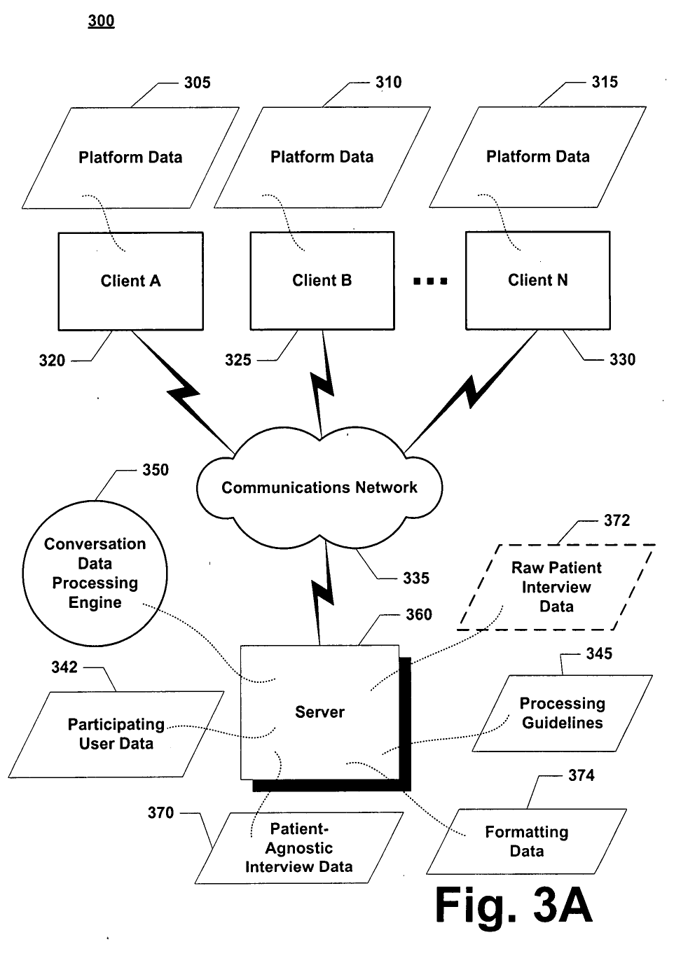

FIG. 3 shows an illustrative implementation of exemplary conversation data environment 300. As is shown in FIG. 3, exemplary conversation data environment 300 comprises client computing environment 320, client computing environment 325 up to and including client computing environment 330, communications network 335, server computing environment 360, conversation data processing engine 350, formatted/redacted conversation data 340, reporting data 349, participating user data 342, and processing guidelines 345. In addition, as is shown by the dashed box, raw conversation data 347 can be temporarily stored for use in generating formatted/redacted conversation data 340. Also, as is shown in FIG. 3, conversation data environment 300 can comprise platform data 305, 310, and 315 (e.g., formatted/redacted conversation data and/or other data including but not limited to participating user data and other party data—e.g., service provider, vendor, supplier, etc.) which can be displayed, viewed, electronically transmitted, searched, copied, retrieved, annotated, navigated, and printed from client computing environments 320, 325, and 330, respectively.

In an illustrative operation, client computing environments 320, 325, and 330 can communicate with server computing environment 360 over communications network 335 to provide requests for and receive platform data 305, 310, and 315. In the illustrative operation, conversation data processing engine 350 can operate on server computing environment 360 to provide one or more instructions to server computing environment 360 to process requests to retrieve platform data 305, 310, and 315 and to electronically communicate platform data 305, 310, and 315 to the requesting client computing environment (e.g., client computing environment 320, client computing environment 325, or client computing environment 335). As part of processing requests to generate and retrieve platform data 305, 310, and 315, conversation data processing engine 350 can utilize a plurality of data including but not limited to formatted/redacted conversation data 340, reporting data 349, processing guidelines 345, temporarily stored raw conversation data 347, and participating user data 342. Also, as is shown in FIG. 3, client computing environments 320, 325, and 330 are capable of processing platform data 305, 310, and 315 using a browser type computing application (not shown) for display and interaction to one or more participating users and/or cooperating parties (not shown).

FIG. 3A shows an illustrative implementation of exemplary conversation data environment 300 for use in an illustrative implementation to electronically capture and process patient interview data. As is shown in FIG. 3, exemplary conversation data environment 300 comprises client computing environment 320, client computing environment 325 up to and including client computing environment 330, communications network 335, server computing environment 360, conversation interview data processing engine 350, patient-agnostic interview data 370, formatting data 374, participating user data 342, and processing guidelines 345. In addition, as is shown by the dashed box, raw patient interview data 372 can be temporarily stored for use in generating patient-agnostic interview data 370. Also, as is shown in FIG. 3, conversation data environment 300 can comprise platform data 305, 310, and 315 (e.g., patient-agnostic interview data and/or other data including but not limited to participating user data and other party data—e.g., physician assistant, patient guardian, etc.) which can be displayed, viewed, electronically transmitted, searched, retrieved, copied, annotated, navigated, and printed from client computing environments 320, 325, and 330, respectively.

As used herein, it is appreciated that patient-agnostic data is not limited to patient sourced data but also is intended to include conversation data provided by any party in an healthcare interaction session including but not limited to physicians, nurses, caregivers, administrators, or other personnel present in an healthcare interaction session.

In an illustrative operation, client computing environments 320, 325, and 330 can communicate with server computing environment 360 over communications network 335 to provide requests for and receive platform data 305, 310, and 315. In the illustrative operation, patient interview data processing engine 350 can operate on server computing environment 360 to provide one or more instructions to server computing environment 360 to process requests to retrieve platform data 305, 310, and 315 and to electronically communicate platform data 305, 310, and 315 to the requesting client computing environment (e.g., client computing environment 320, client computing environment 325, or client computing environment 335). As part of processing requests to generate and retrieve platform data 305, 310, and 315, conversation data processing engine 350 can utilize a plurality of data including but not limited to patient-agnostic interview data 370, formatting data 374, processing guidelines 345, participating user data 342, and temporarily stored raw patient interview data 372. Also, as is shown in FIG. 3, client computing environments 320, 325, and 330 are capable of processing platform data 305, 310, and 315 using a browser type computing application (not shown) for display and interaction to one or more participating users and/or cooperating parties (not shown).

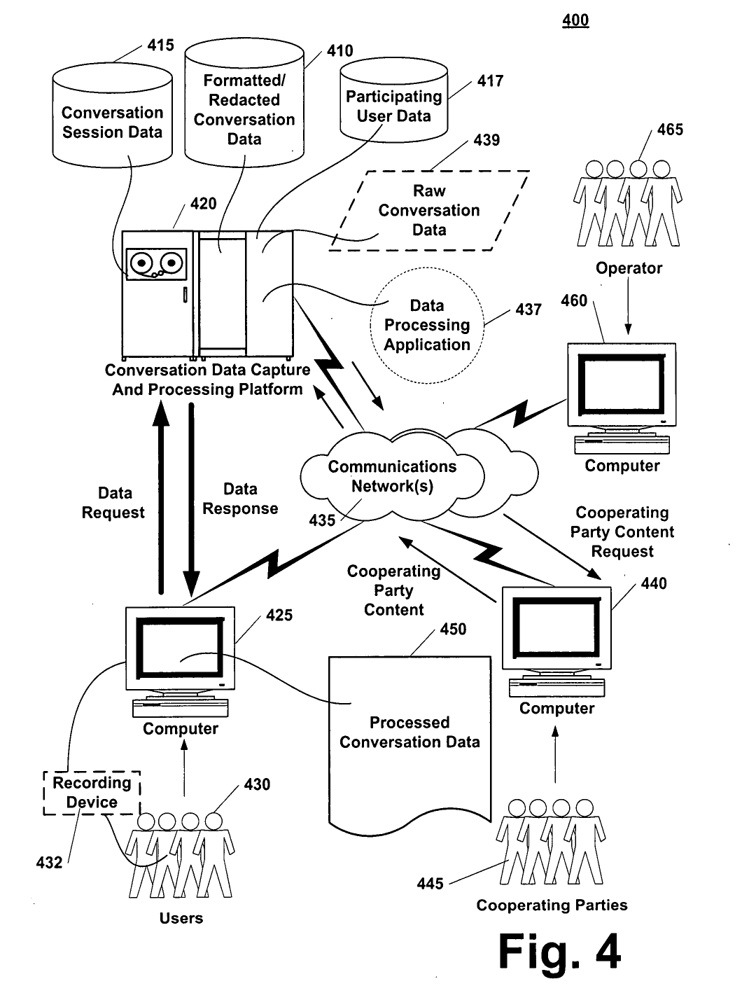

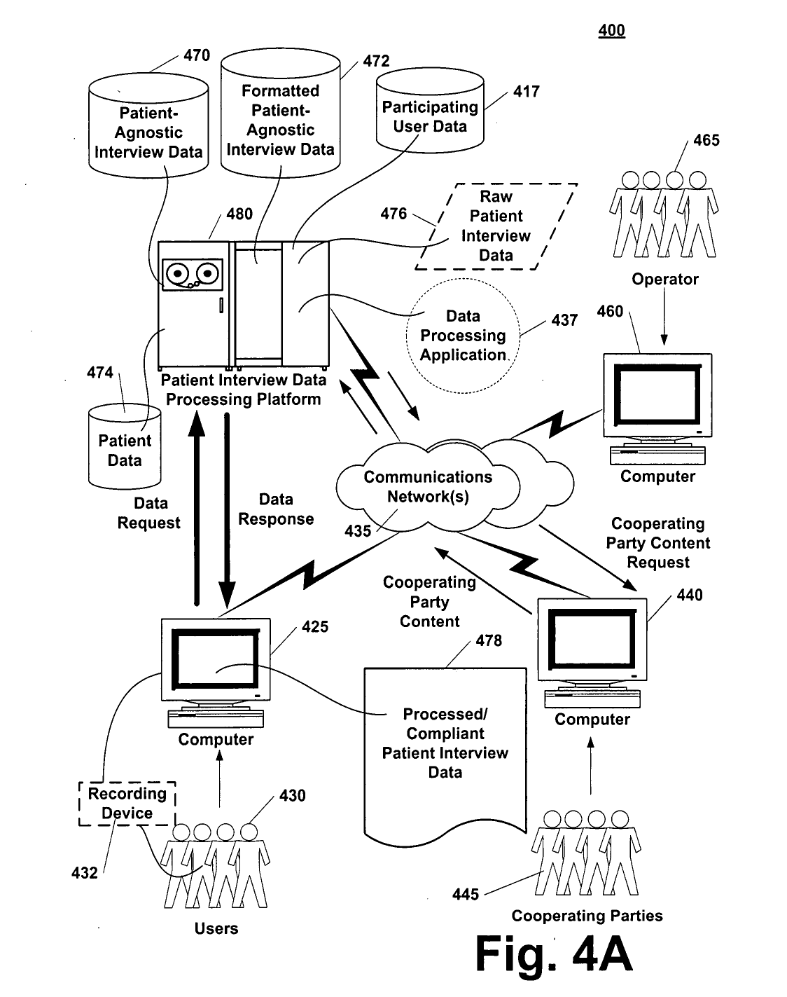

FIG. 4 shows a detailed illustrative implementation of an exemplary conversation data environment 400. As is shown in FIG. 4, exemplary conversation data environment 400 comprises conversation data capture and processing platform 420, conversation session data store 415, participating user data store 417, formatted/redacted conversation data store 410, data processing application 437, user computing environment 425, users 430, cooperating party computing environment 440, cooperating parties 445, operator computing environment 460, and operators 465. Additionally, as is shown in FIG. 4, conversation data environment 400 can comprise processed conversation data 450 which can be displayed, viewed, transmitted, searched, retrieved, copied, annotated, navigated, and/or printed from user computing environment 425, cooperating party computing environment 440, and/or operator computing environment 460. Further as is shown, user computing environment can cooperate with recording means 432 (e.g., conversation capture device) as part of conversation data capturing operations.

In an illustrative implementation, conversation data capture and processing platform 420 can be electronically coupled to user computing environment 425, cooperating party computing environment 440, and operator computing environment 460 via communications network 435. In the illustrative implementation, communications network can comprise fixed-wire and/or wireless intranets, extranets, and the Internet.

In an illustrative operation, users 430 can interact with patient interview data user interface (not shown) operating on user computing environment 425 to communicate data indicative of raw and/or processed conversation data sessions (e.g., sales call, customer relationship management, call centers, insurance policy interview, financial planning session, auto accident report, etc.) that are passed across communications network 435 to conversation data capture and processing platform 420. In the illustrative operation, conversation data capture and processing platform 420 can process requests for user-agnostic conversation data and cooperate with conversation session data store 415 and/or participating user data store 417 using data processing application to generate formatted/redacted conversation data for use by users 430, cooperating parties 445, and operators 465. Further, in the illustrative operation, conversation data capture and processing platform 420 can receive data representative of raw conversation data (e.g., data electronically recorded in real-time during a conversation session—e.g., during a financial planning session), temporarily store (as indicated by the dashed lines) the received raw conversation data 439 and process the raw conversation data using data processing application 437 to generate user-agnostic conversation data for storage into conversation data store 415. Additionally, in the illustrative operation, the temporarily stored raw conversation data 439 can be deleted from conversation data capture and processing platform 420 once user-agnostic agnostic conversation data 415 is generated to comply with rules and regulations governing user data privacy (i.e., as per a selected data privacy policy).

Furthermore, in the illustrative operation, participating users (e.g., service providers, vendors, users, etc.) can input associated user data which can be stored for subsequent processing and/or retrieval in participating user data store 417.

In an illustrative implementation, raw conversation data 439 can comprise data representative of the real-time recording of the interaction between a user and a service provider/vendor/supplier (and others who are present during the conversation data session—e.g., family members, guardians, custodians, attorneys, etc.). In the illustrative implementation, conversation session data store 415 can comprise data that does not contain any user identifiers (e.g., “scrubbed” data). Formatted/redacted conversation data store 410 can comprise user-agnostic data that is formatted according to one or more selected templates (not shown) for presentation to cooperating parties (e.g., consumers of user-agnostic interview data). Additionally, in an illustrative implementation, formatted/redacted conversation data 410 can comprise data that is coded according to one or more selected coding paradigms to provide a quick reference for future search and retrieval operations. Additionally, formatted/redacted data store 410 can comprise various reports (reporting data 349 of FIG. 3) that can be generated by data processing application 437.

In the illustrative operation, responsive to the requests from users 430 to communicate raw conversation data 439 and/or retrieve conversation session data 415, conversation data capture and processing platform 420 can process the requests and cooperate with one or more of the environment data stores to store and/or retrieve conversation data (raw and/or user-agnostic conversation data). In the illustrative implementation, cooperating party computing environment 440 can comprise a computing environment for use by user-agnostic conversation data consumers (e.g., market research companies, managers of salesforces/customer service personnel) to retrieve generated conversation session data (and/or formatted/redacted conversation data) for subsequent processing and consideration. Furthermore, in the illustrative implementation, operator computing environment 460 can be used by operators 465 to electronically monitor, track, analyze, and report (e.g., in real time or post-facto) the generation and delivery of conversation session data (and/or formatted/redacted conversation data) and participating user data 417.

In the illustrative operation, participating users 430 can employ conversation data capture and processing platform to share conversation session and/or formatted/redacted conversation data with one or more affiliates and/or delegates of the participating user as part of a selected management and execution strategy. In an illustrative implementation, a participating user 430 can share conversation session data and/or formatted/redacted conversation data captured during a financial planning session with his/her financial planner with his/her estate attorney as part of an effort to identify, optimize, and execute a multi-generational wealth management plan.

In the illustrative operation, participating users 430 can employ one or more features of exemplary conversation data capture and processing platform to apply one or more portions of a social networking paradigm to optimize the user's experience and/or resolve an outstanding issue or query. In an illustrative implementation, participating user 430 can collaborate with other participating users 430 who employ conversation data capture and processing platform 420 to obtain feedback regarding a selected issue/query. For example, a participating user 430 can listen to other conversation session data 415 and access participating user data generated by other participating users 430 for a particular experience (e.g., buying a car) in anticipation of a undertaking a similar experience. Such resource can assist the inquiring participating user significantly to improve the experience and/or avoid unnecessary pitfalls with the given experience (e.g., to not buy a car from XYZ dealership given its hostile sales force, to expect a K% discount when negotiating with DEF company, or to talk baseball with ABC salesperson who is a baseball nut to disarm ABC, etc.).

FIG. 4A shows a detailed illustrative implementation of an exemplary conversation data environment 400 for use in an illustrative implementation to capture and process patient interview data. As is shown in FIG. 4A, exemplary conversation data environment 400 comprises patient interview data processing platform 480, patient-agnostic interview data store 470, participating user data store 417, patient data store 474, formatted patient-agnostic interview data store 472, raw patient interview data 474, data processing application 437, user computing environment 425, users 430, cooperating party computing environment 440, cooperating parties 445, operator computing environment 460, and operators 465. Additionally, as is shown in FIG. 4A, conversation data environment 400 can comprise processed/compliant patient-agnostic interview data 478 (e.g., compliant with a selected patient data privacy policy) which can be displayed, viewed, transmitted, searched, retrieved, navigated, copied, annotated, and/or printed from user computing environment 425, cooperating party computing environment 440, and/or operator computing environment 460. Further as is shown, user computing environment can cooperate with recording means 432 (e.g., conversation capture device) as part of patient interview data capturing operations.

In an illustrative implementation, patient interview data platform 480 can be electronically coupled to user computing environment 425, cooperating party computing environment 440, and operator computing environment 460 via communications network 435. In the illustrative implementation, communications network can comprise fixed-wire and/or wireless intranets, extranets, and the Internet.

In an illustrative operation, users 430 can interact with patient interview data user interface (not shown) operating on user computing environment 425 to communicate data indicative of raw and/or processed patient interview sessions (e.g., patient/doctor interaction sessions—what is communicated between a patient and doctor during a patient/doctor interview) that are passed across communications network 435 to patient interview data processing platform 480. In the illustrative operation, patient interview data processing platform 480 can process requests for patient-agnostic interview data and cooperate with patient-agnostic interview data store 470, participating user data store 417, and/or patient data store 474 using data processing application to generate formatted patient-agnostic interview data for use by users 430, cooperating parties 445, and operators 465. Further, in the illustrative operation, patient interview data processing platform 480 can receive data representative of raw patient interview data (e.g., data electronically recorded in real-time as a patient/doctor interaction session is occurring), temporarily store (as indicated by the dashed lines) the received raw patient interview data 476 and process the raw patient interview data 476 using data processing application 437 to generate patient-agnostic interview data for storage into patient-agnostic interview data store 470. Additionally, in the illustrative operation, the temporarily stored raw patient interview data 476 can be deleted from patient interview data processing platform 480 once the patient-agnostic interview data 475 is generated to comply with rules and regulations governing patient data privacy (i.e., as per a selected patient data privacy policy).

Furthermore, in the illustrative operation, participating users (e.g., doctors and/or patients) can input associated patient data which can be stored in patient data store 474. Also, participating users can input participating user data for storage, processing, and/or retrieval into participating user data store 417.

In an illustrative implementation, raw patient interview data 476 can comprise data representative of the real-time recording of the interaction between a patient and doctor (and others who are present during the patient/doctor interaction session—e.g., doctor assistants, nurses, patient guardians, etc.). Such data can include but is not limited obtaining by the doctor: a medical history of the patient, pharmacological history of the patient, and a history of symptoms and attempted remedies of the patient. In the illustrative implementation, patient-agnostic interview data store 470 can comprise data that does not contain any patient identifiers (e.g., “scrubbed” data). Formatted patient-agnostic interview data store 472 can comprise patient-agnostic data that is formatted according to one or more selected templates (not shown) for presentation to cooperating parties (e.g., consumers of patient-agnostic interview data). Additionally, in an illustrative implementation, formatted patient-agnostic interview data 472 can comprise data that is coded according to one or more selected coding paradigms to provide a quick reference for future search and retrieval operations. Additionally, formatted patient-agnostic interview data store 472 can comprise various reports (not shown) that can be generated by data processing application 437.

In the illustrative operation, responsive to the requests from users (e.g., doctors) 430 to communicate raw patient interview data 476 and/or retrieve patient-agnostic interview data 470, patient interview data processing platform 480 can process the requests and cooperate with one or more of the environment stores to store and/or retrieve patient interview data (raw and/or patient agnostic interview data). In the illustrative implementation, cooperating party computing environment 440 can comprise a computing environment for use patient-agnostic interview data consumers (e.g., pharmaceutical companies) to retrieve generated patient-agnostic interview data (and/or formatted patient-agnostic interview data) for subsequent processing and consideration. Furthermore, in the illustrative implementation, operator computing environment 460 can be used by operators 465 to electronically monitor, track, analyze, and report (e.g., in real time or post-facto) the generation and delivery of patient-agnostic interview data (and/or formatted patient-agnostic interview data).

In the illustrative operation, participating users 430 can employ one or more features of exemplary conversation data capture and processing platform to apply one or more portions of a social networking paradigm to optimize the user's experience and/or resolve an outstanding issue or query. In an illustrative implementation, participating user 430 can collaborate with other participating users 430 who employ patient interview data processing platform 480 to obtain feedback regarding a selected issue/query. For example, a participating user 430 can listen to other conversation session data 415 and access participating user data generated by other participating users 430 for a particular experience (e.g., selecting a physician) in anticipation of a undertaking a similar experience. Such resource can assist the inquiring participating user significantly to improve the experience and/or avoid unnecessary pitfalls with the given experience (e.g., to not take XYZ medicine for DEF condition if you also have IJK condition). In this illustrative implementation and operation, the data can be shared according to authorization that is capable of being provided by the owner/source of the conversation data (e.g., healthcare interaction session data).

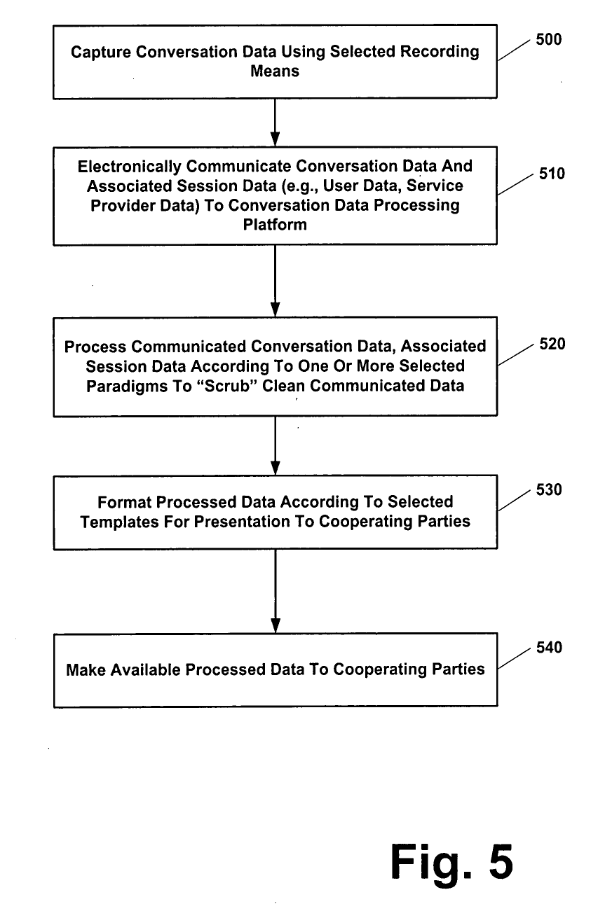

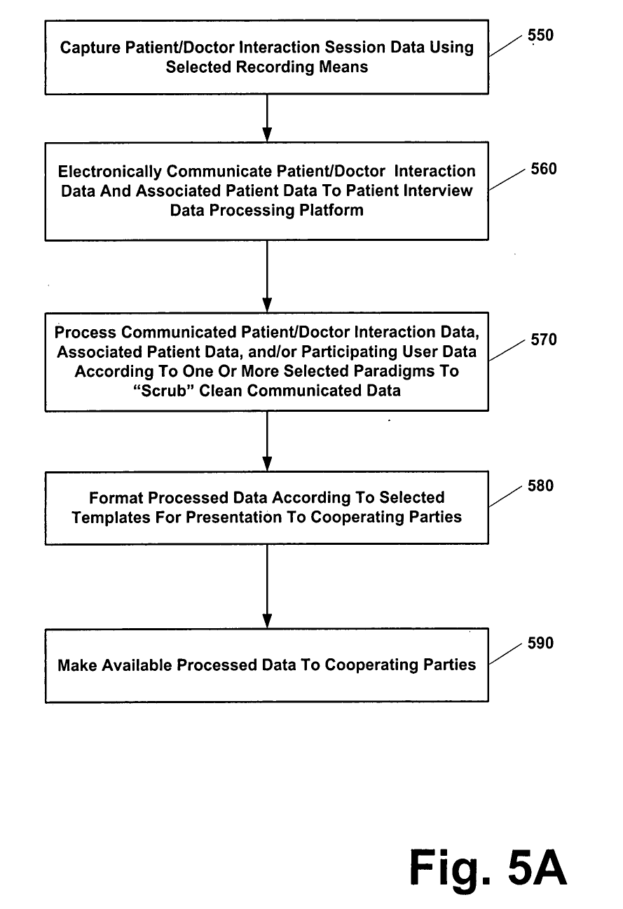

FIG. 5 shows exemplary processing performed when using an illustrative implementation of conversation data environment 400 of FIG. 4. As is shown, processing begins at block 500 where conversation data is captured using a selected recording means (e.g., electronic recording means—audio/video recorder, mobile telephone, PDA, etc.). From there processing proceeds to block 510 where the captured electronically recorded data is electronically communicated to conversation data processing platform. Additionally, at block 510, a service provider/vendor/conversant can electronically communicate associated conversation session data (e.g., user financial planning history, auto purchasing history, insurance coverage information, etc.) to the conversation data platform for association and processing. From there processing proceeds to block 520 where the communicated conversation data, conversation session data, and/or participating user data can processed according to one or more selected paradigms (e.g., data filtering algorithms) to “scrub” clean the communicated data to generate user-agnostic conversation data if preferred (user specific data can also be generated and stored as a preference). Additionally at block 520, the captured electronically recorded conversation data can be transcribed as part of processing to facilitate storage and use of such data.

Processing then proceeds to block 530 where the generated user-agnostic interview data is formatted to one or more selected templates for presentation to one or more cooperating parties (e.g., consumers of user-agnostic interview data such as market research companies, managers, evaluators, the participating users themselves, etc.). Additionally, at block 530, the generated data can be electronically coded to facilitate subsequent processing and retrieval. Also, in an illustrative operation, at block 530, the generated conversation data (e.g., user-agnostic and/or user-specific data) can be used to generate one or more reports representative of one or more of the conversation data sessions according to one or more selected criteria (e.g., a report can be generated to indicate all the interaction sessions in which a user maintains a particular affinity such as expensive luxury cars). At block 540 the processed data (e.g., generated conversation data, conversation session data, participating user data, and/or formatted conversation data) can be made available to cooperating parties.

FIG. 5A shows exemplary processing performed when using an illustrative implementation of conversation data environment 400 of FIG. 4A to electronically capture and process patient interview data. As is shown, processing begins at block 550 where patient/doctor interaction data is captured using a selected recording means (e.g., electronic recording means—audio/video recorder). From there processing proceeds to block 560 where the captured electronically recorded data is electronically communicated to patient interview data processing platform. Additionally, at block 560, a doctor can electronically communicate associated patient data (e.g., patient chart information through the use of a user interface). From there processing proceeds to block 570 where the communicated patient/doctor interview data, patient data, and/or participating user data is processed according to one or more selected paradigms (e.g., data filtering algorithms) to “scrub” clean the communicated data to generate patient-agnostic interview data. Additionally at block 570, the captured electronically recorded patient/doctor interview data can be transcribed as part of processing to facilitate storage and use of such data.

Processing then proceeds to block 580 where the generated patient-agnostic interview data is formatted to one or more selected templates for presentation to one or more cooperating parties (e.g., consumers of patient-agnostic interview data). Additionally, at block 580, the generated data can be electronically coded to facilitate subsequent processing and retrieval. Also, in an illustrative operation, at block 580, the generated patient-agnostic interview data can be used to generate one or more reports representative of one or more of the patient/doctor interaction sessions according to one or more selected criteria (e.g., a report can be generated to indicate all the interaction sessions in which a patient suffers reflux disease and is being treated using one or more pharmaceutical products—a proton pump inhibitor). At block 590 the processed data (e.g., generated patient-agnostic interview data, patient data, participating user data, and/or formatted patient-agnostic interview data) can be made available to cooperating parties and users themselves.

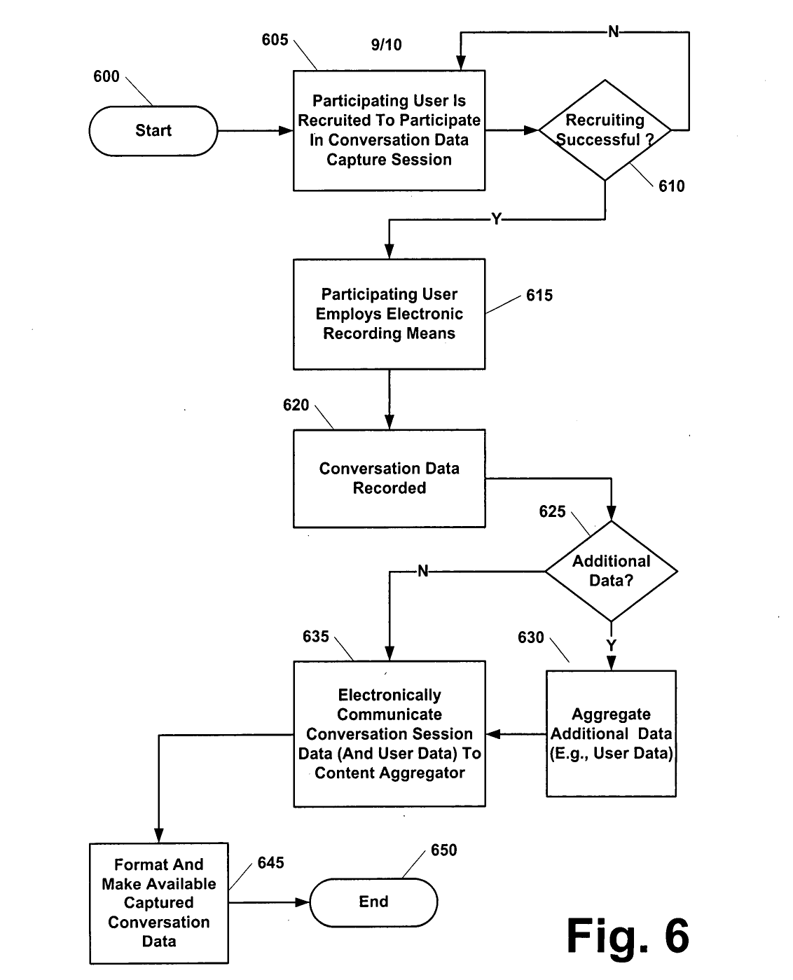

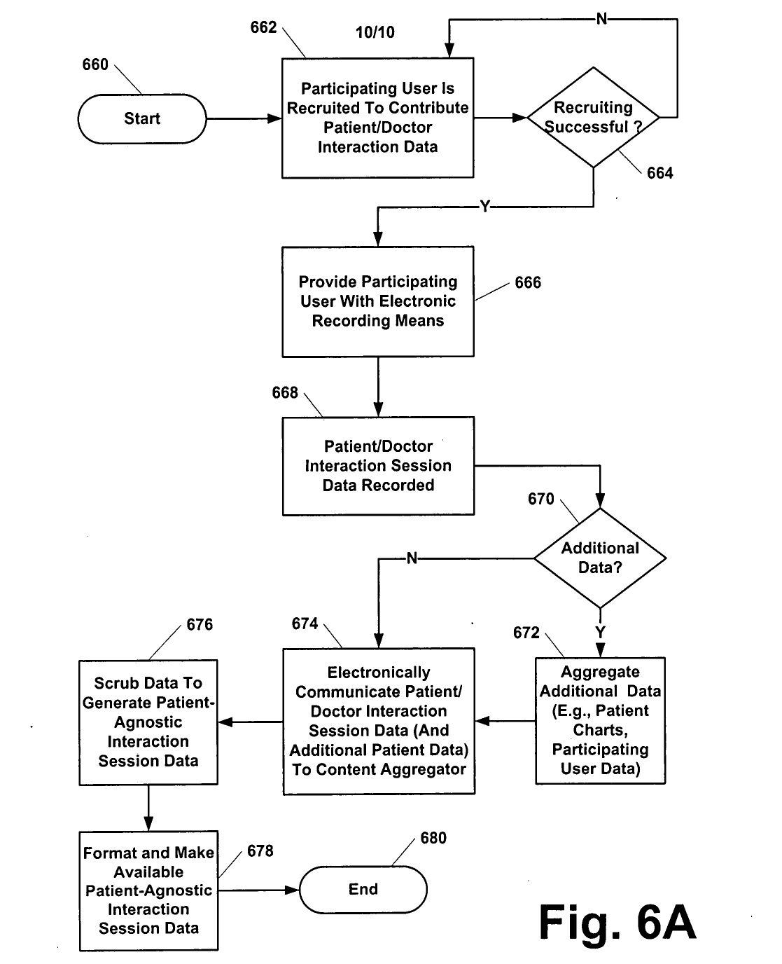

FIG. 6 shows other processing performed by an exemplary conversation data environment 400 of FIG. 4. As is shown, processing begins at block 600 and proceeds to block 605 where a participating user is recruited to contribute conversation data capture data. In an illustrative implementation a participating user can comprise the user/customer/client and/or service provider/vendor/supplier capable of capturing conversation session data. From block 605, processing proceeds to block 610 where a check is performed to determine if the recruitment of the participating user was successful. If the check at block 610 indicates that the recruiting effort was not successful, processing reverts to block 605 and proceeds from there.

However, if the check at block 610 indicates that the recruiting effort of block 605 was successful, processing proceeds to block 615 where the participating user employs an electronic recording means. In an illustrative implementation, the recording mean can comprise audio/video recording instrumentalities such as a digital voice recorder, a mobile phone, a PDA, or other electronic device capable of capturing conversation data (e.g., audio, video, and/or text conversation data). From block 615, processing proceeds to block 620 where the conversation data is recorded. A check is then performed at block 625 to determine if additional conversation session data (e.g., user purchase history) is to be communicated by the participating user and to be used when processing recorded conversation data recorded at block 620. If the check at block 625 indicates that additional conversation session data is to be communicated and used in conjunction with the recorded conversation data recorded at block 620, processing proceeds to block 630 where the additional conversation session data and/or participating user data is aggregated and/or inputted (e.g., according to a user interface operating on a computing application as part of the conversation data environment 400). From there processing proceeds to block 635 and continues thereon.

However, if the check at block 625 indicates that additional conversation session data and/or participating user data is not to be used, processing proceeds to block 635 where the conversation data is electronically communicated to a content aggregator (e.g., conversation data capture and processing platform 420 of FIG. 4 or patient interview data processing platform 480 or FIG. 4A). The patient-agnostic interaction session data can then be further processed at block 645 to generate formatted conversation data. Additionally, at block 645, the formatted (and/or the non-formatted) generated conversation data can be made available for use by participating users, cooperating parties (e.g., consumers of conversation data), and operators (e.g., service providers operating to aggregate raw conversation data and generating formatted and non-formatted conversation data). Processing then terminates at block 650.

FIG. 6A shows other processing performed by an exemplary conversation data environment 400 of FIG. 4 in an illustrative implementation to capture patient interview data. As is shown, processing begins at block 660 and proceeds to block 662 where a participating user is recruited to contribute patient/doctor interaction data. In an illustrative implementation a participating user can comprise the patient, a doctor, or other healthcare practitioner capable of capturing patient/doctor interaction session data. From block 662, processing proceeds to block 664 where a check is performed to determine if the recruitment of the participating user was successful. If the check at block 664 indicates that the recruiting effort was not successful, processing reverts to block 662 and proceeds from there.

However, if the check at block 664 indicates that the recruiting effort of block 662 was successful, processing proceeds to block 666 where the participating user is provided with an electronic recording means. In an illustrative implementation, the recording mean can comprise audio/video recording instrumentalities such as a digital voice recorder, a mobile phone, a PDA, or other electronic device capable of capturing conversation data (e.g., audio, video, and/or text conversation data). From block 666, processing proceeds to block 668 where the patient/doctor interaction is data is recorded. A check is then performed at block 670 to determine if additional patient data (e.g., patient chart data) is to be communicated by the participating user and to be used when processing recorded patient/doctor interaction session data recorded at block 668. If the check at block 670 indicates that additional patient data is to be communicated and used in conjunction with the recorded patient/doctor interaction data recorded at block 668, processing proceeds to block 672 where the additional patient data and/or participating user data is aggregated and/or inputted (e.g., according to a user interface operating on a computing application as part of the conversation data environment 400). From there processing proceeds to block 674 and continues thereon.

However, if the check at block 670 indicates that additional patient and/or participating user data is not to be used, processing proceeds to block 674 where the patient/doctor interaction session data is electronically communicated to a content aggregator (e.g., patient interview data processing platform 480 of FIG. 4A). Additionally, illustratively, raw healthcare interaction session data can be retrieved and provided to users (i.e., owners/sources of the captured data) at block 674. From there, processing proceeds to block 676 where the data is “scrubbed” (i.e., patient and/or participating user identifiers removed) to generate patient-agnostic interaction session data. The patient-agnostic interaction session data can then be further processed at block 678 to generate formatted patient-agnostic interaction session data. Additionally, at block 678, the formatted (and/or the non-formatted) generated patient-agnostic interaction session data can e made available for use by participating users, cooperating parties (e.g., consumers of patient-agnostic interview data—pharmaceutical companies), and operators (e.g., service providers operating to aggregate raw patient/doctor interview data and generating formatted and non-formatted patient-agnostic interview data). Processing then terminates at block 680.

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both non-wireless and wireless computer environments), partial computing environments, and real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus can also be considered to be implemented as a computer-readable storage medium, configured with a computer program, where the storage medium so configured causes a computer to operate in a specific and predefined manner.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

What is claimed is:

1. A computer-implemented interactive method for the electronic capture and processing of conversation data comprising:
receiving electronic data representative of a conversation session from a participating user;
processing the received conversation interaction session data along with data representative of the participating user to generate processed conversation data according to one or more selected data processing paradigms; and
making available the generated processed conversation data to cooperating parties.

2. The method as recited in claim 1 further comprising employing a recording means to the participating user operable to electronically record conversation session data.

3. The method as recited in claim 1 further comprising processing the generated processed data according to one or more selected formats for communication to cooperating parties.

4. The method as recited in claim 1 further comprising storing the generated patient-agnostic data.

5. The method as recited in claim 1 further comprising deleting the received electronic data representative of a conversation session upon generating the processed data to comply with a selected patient data privacy policy.

6. A computer-readable medium that contains instructions which, when executed by a processor, causes the processor to perform the method of capturing and processing patient interview data comprising the steps of:
providing a graphical user interface operable to receive and display interactive receiving electronic data representative of a conversation session from a participating user;
processing the received conversation data along with data representative of the participating user to generate processed conversation data according to one or more selected data processing paradigms; and
making available the generated processed conversation data to cooperating parties

7. A method to aggregate conversation data comprising:
receiving by a computing application operable to receive electronically recorded conversation data and/or participating user data from a cooperating electronic recording means;
formatting the received conversation data according to one or more selected format templates; and
providing access to the formatted conversation data to cooperating parties.

8. The method as recited in claim 7 further comprising providing access to the received electronically recorded conversation data to the participating user.

9. The method as recited in claim 7 further comprising providing access to the formatted conversation data to the participating user.

10. The method as recited in claim 7 further comprising communicating the electronically recorded conversation data to a content aggregator using the computing application over a communications network.

11. The method as recited in claim 10 further comprising communicating the formatted conversation data to the cooperating parties over a communications network.

12. The method as recited in claim 7 further comprising deleting the received electronically recorded data representative of a conversation session upon generating the formatted conversation data to comply with privacy rules and regulations.

13. A system for capturing and processing conversation data comprising:
a data store; and
an interactive conversation data processing engine operable on the data store to perform an operation comprising tracking, searching, and retrieving conversation data,
wherein the conversation data comprises electronically recorded data, recorded by a participating user, arising from a selected conversation session and/or data representative of a participating user.

14. The system as recited in claim 13 wherein data store comprises generated raw conversation data, formatted conversation data, participating user data, and format templates that can be used in formatting patient/data interaction session data.

15. The system as recited in claim 14 further comprising a computing environment.

16. The system as recited in claim 15 further comprising a networked computing environment.

17. The system as recited in claim 16 further wherein the conversation data processing engine comprises a computing application operating on the computing environment.

18. The system as recited in claim 17 further comprising a graphical user interface operable to display and navigate data provided by the conversation data processing engine.

19. The system as recited in claim 18 wherein the data provided by the conversation data processing engine comprises conversation session data.

20. The system as recited in claim 19 wherein the graphical user interface is operable on the computing environment to display electronically captured conversation data.

21. A computer-implemented interactive method for the capture and processing of patient interview data comprising:
receiving electronic data representative of a patient/doctor interaction session from a participating user;
processing the received patient/doctor interaction session data along with data representative of the participating user to generate patient-agnostic data according to one or more selected data processing paradigms; and
making available the generated patient agnostic data to cooperating parties.

22. The method as recited in claim 21 further comprising providing a recording means to the participating user operable to electronically record patient/doctor interaction session data.

23. The method as recited in claim 21 further comprising processing the generated data according to one or more selected formats for communication to cooperating parties.

24. The method as recited in claim 21 further comprising storing the generated patient-agnostic data.

25. The method as recited in claim 21 further comprising complying with a selected patient data privacy policy to deliver generated patient-agnostic data.

26. A computer-readable medium that contains instructions which, when executed by a processor, causes the processor to perform the method of capturing and processing patient interview data comprising the steps of:
providing a graphical user interface operable to receive and display interactive receiving electronic data representative of a patient/doctor interaction session from a participating user;
processing the received patient/doctor interaction session data along with data representative of the participating user to generate patient-agnostic data according to one or more selected data processing paradigms; and
making available the generated patient agnostic data to cooperating parties

27. A method to aggregate patient interview data comprising:
providing an electronic recording means to a participating user operable to electronically record patient/doctor interaction session data;
providing access to a computing application to the participating user operable receive electronically recorded patient/doctor interaction session data and/or participating user data;
receiving electronically recorded patient/doctor interaction session data;
processing the received patient/doctor interaction session data and/or participating user data to remove indicators of the patient and/or participating user identity to generate patient-agnostic interview data so as to comply with a selected patient data privacy policy;
formatting the processed patient-agnostic interview data according to one or more selected format templates; and
providing access to a computing application to cooperating parties to provide access to the formatted patient-agnostic interview data.

28. The method as recited in claim 27 further comprising providing access to the generated patient-agnostic data to the participating user.

29. The method as recited in claim 27 further comprising providing access to the formatted patient-agnostic data to the participating user.

30. The method as recited in claim 27 further comprising communicating the electronically recorded patient/doctor interaction session data to a content aggregator using the computing application over a communications network.

31. The method as recited in claim 30 further comprising communicating the formatted patient-agnostic interview data to the cooperating parties using the computing application over a communications network.

32. The method as recited in claim 27 further comprising deleting the received electronically recorded data representative of a patient/doctor interaction session upon generating the patient-agnostic data to comply with patient privacy rules and regulations.

33. A system for capturing and processing patient interview data comprising:
a data store; and
an interactive patient interview data processing engine operable on the data store to perform an operation comprising tracking, searching, and retrieving patient/doctor interaction session data,
wherein the patient/doctor interaction session data comprises electronically recorded data, recorded by a participating user, arising from a patient/doctor interaction session and/or data representative of a participating user.

34. The system as recited in claim 33 wherein data store comprises generated patient-agnostic interview data, formatted patient agnostic interview data, patient data, participating user data, and format templates that can be used in formatting patient/data interaction session data.

35. The system as recited in claim 34 further comprising a computing environment.

36. The system as recited in claim 35 further comprising a networked computing environment.

37. The system as recited in claim 36 further wherein the patient interview data processing engine comprises a computing application operating on the computing environment.

38. The system as recited in claim 37 further comprising a graphical user interface operable to display and navigate data provided by the patient interview data processing engine.

39. The system as recited in claim 38 wherein the data provided by the patient interview data processing engine comprises patient-agnostic interview data.

40. The system as recited in claim 39 wherein the graphical user interface is operable on the computing environment to display patient-agnostic interview data.
